(19) United States
(12) Patent Application Publication
(10) Pub. No.: US 2026/0138604 A1
(43) Pub. Date: May 21, 2026

(54) METHODS, SYSTEMS, AND STORAGE MEDIUMS FOR AUTONOMOUS DRIVING LANE-KEEPING CONTROL

(71) Applicant: ZHEJIANG SIQIAN AUTONOMOUS DRIVING TECHNOLOGY CO., LTD., Huzhou (CN)

(72) Inventors: Ran CHEN, Beijing (CN); Yanjun WU, Beijing (CN); Yi LIU, Beijing (CN); Bei HE, Huzhou (CN)

(73) Assignee: ZHEJIANG SIQIAN AUTONOMOUS DRIVING TECHNOLOGY CO., LTD., Huzhou (CN)

(21) Appl. No.: 19/448,033

(22) Filed: Jan. 13, 2026

Related U.S. Application Data
(63) Continuation-in-part of application No. PCT/CN2024/108490, filed on Jul. 30, 2024.

(30) Foreign Application Priority Data
Aug. 16, 2023 (CN) 202311033160.1

(51) Int. Cl. B60W 30/12; G06V 20/56

(52) U.S. Cl. CPC B60W 30/12; G06V 20/588; B60W 2520/12; B60W 2520/14

(57) ABSTRACT

Embodiments of the present disclosure provide a method, a system, and a storage medium for autonomous driving lane-keeping control, which may achieve a high-precision lane-keeping function on the straight lanes with weak GPS signals and the narrow straight lanes. The method includes: within a control cycle, obtaining a deviation observation value of an ego vehicle relative to a lane centerline corresponding to a current moment based on a deviation of the ego vehicle relative to the lane centerline corresponding to a previous moment and a deviation observation value of the ego vehicle relative to the lane centerline corresponding to the previous moment; correcting an ego vehicle position corresponding to the current moment based on the deviation observation value of the ego vehicle relative to the lane centerline corresponding to the current moment; obtaining a lane centerline corresponding to the current moment based on a corrected ego vehicle position; and generating a current path based on the lane centerline corresponding to the current moment, and performing lane-keeping control based on the current path.

### CROSS-REFERENCE TO RELATED APPLICATIONS

This application is a continuation-in-part of International Application No. PCT/CN2024/108490, filed on Jul. 30, 2024, which claims priority to Chinese Patent Application No. 202311033160.1, filed on Aug. 16, 2023, the entire contents of each of which are hereby incorporated by reference.

### TECHNICAL FIELD

The present disclosure relates to the field of autonomous driving, and in particular to a method, a system, and a storage medium for autonomous driving lane-keeping control.

### BACKGROUND

A lane-keeping control mode is a common mode of autonomous driving technology, which may achieve autonomous driving by identifying and tracking a lane centerline. However, positioning on straight lanes with weak GPS signals and narrow straight lanes (e.g., narrow straight lanes in port yards where GPS signals are obscured by containers stacked on both sides of the road) is unstable, and autonomous driving may trigger dangerous situations.

Therefore, there is a desire to provide an autonomous driving lane-keeping control solution that may achieve a high-precision lane-keeping function on the straight lanes with weak GPS signals and the narrow straight lanes.

### SUMMARY

One or more embodiments of the present disclosure provide a system for autonomous driving lane-keeping control. The system includes an observation value acquisition module, a correction module, a lane centerline acquisition module, and a path generation module. The observation value acquisition module is configured to, within a control cycle, obtain a deviation observation value of an ego vehicle relative to a lane centerline corresponding to a current moment, based on a deviation of the ego vehicle relative to the lane centerline corresponding to a previous moment and a deviation observation value of the ego vehicle relative to the lane centerline corresponding to the previous moment, wherein the deviation of the ego vehicle relative to the lane centerline corresponding to the previous moment is obtained based on a detection cycle. The observation value acquisition module is further configured to: based on a lateral velocity and a yaw rate change of the ego vehicle, obtain an increment of the deviation of the ego vehicle relative to the lane centerline corresponding to the previous moment within the control cycle; based on the increment of the deviation of the ego vehicle relative to the lane centerline corresponding to the previous moment within the control cycle and the deviation observation value of the ego vehicle relative to the lane centerline corresponding to the previous moment, determine a deviation estimation of the ego vehicle relative to the lane centerline corresponding to the current moment; and through an observer, based on the deviation estimation of the ego vehicle relative to the lane centerline corresponding to the current moment, the deviation of the ego vehicle relative to the lane centerline corresponding to the previous moment, and the deviation observation value of the ego vehicle relative to the lane centerline corresponding to the previous moment, obtain the deviation observation value of the ego vehicle relative to the lane centerline corresponding to the current moment. The observer is a diagonal matrix, the diagonal matrix includes a first coefficient and a second coefficient, and the first coefficient and the second coefficient are greater than 0 and less than 1; the first coefficient corresponds to a confidence level of the deviation of the ego vehicle relative to the lane centerline corresponding to the previous moment, and the second coefficient corresponds to a confidence level of the deviation observation value of the ego vehicle relative to the lane centerline corresponding to the previous moment; and at least one of the first coefficient and the second coefficient is determined based on ego vehicle environment information. The correction module is configured to correct an ego vehicle position corresponding to the current moment based on the deviation observation value of the ego vehicle relative to the lane centerline corresponding to the current moment. The lane centerline acquisition module is configured to obtain a lane centerline corresponding to the current moment based on a corrected ego vehicle position. The path generation module is configured to generate a current path based on the lane centerline corresponding to the current moment, and perform lane-keeping control based on the current path.

One or more embodiments of the present disclosure provide a method for autonomous driving lane-keeping control. The method includes: within a control cycle, obtaining a deviation observation value of an ego vehicle relative to a lane centerline corresponding to a current moment based on a deviation of the ego vehicle relative to the lane centerline corresponding to a previous moment and a deviation observation value of the ego vehicle relative to the lane centerline corresponding to the previous moment, wherein the deviation of the ego vehicle relative to the lane centerline corresponding to the previous moment is obtained based on a detection cycle, including: based on a lateral velocity and a yaw rate change of the ego vehicle, obtaining an increment of the deviation of the ego vehicle relative to the lane centerline corresponding to the previous moment within the control cycle; based on the increment of the deviation of the ego vehicle relative to the lane centerline corresponding to the previous moment within the control cycle and the deviation observation value of the ego vehicle relative to the lane centerline corresponding to the previous moment, determining a deviation estimation of the ego vehicle relative to the lane centerline corresponding to the current moment; and through an observer, based on the deviation estimation of the ego vehicle relative to the lane centerline corresponding to the current moment, the deviation of the ego vehicle relative to the lane centerline corresponding to the previous moment, and the deviation observation value of the ego vehicle relative to the lane centerline corresponding to the previous moment, obtaining the deviation observation value of the ego vehicle relative to the lane centerline corresponding to the current moment; correcting an ego vehicle position corresponding to the current moment based on the deviation observation value of the ego vehicle relative to the lane centerline corresponding to the current moment; obtaining a lane centerline corresponding to the current moment based on a corrected ego vehicle position; and generating a current path based on the lane centerline corresponding to the current moment, and performing lane-keeping control based on the current path. The observer is a diagonal matrix, the diagonal matrix includes a first coefficient and a second coefficient, and the first coefficient and the second coefficient are greater than 0 and less than 1; the first coefficient corresponds to a confidence level of the deviation of the ego vehicle relative to the lane centerline corresponding to the previous moment, and the second coefficient corresponds to a confidence level of the deviation observation value of the ego vehicle relative to the lane centerline corresponding to the previous moment; and at least one of the first coefficient and the second coefficient is determined based on ego vehicle environment information.

One or more embodiments of the present disclosure provide a device for autonomous driving lane-keeping control. The device includes at least one storage medium, storing computer instructions; and at least one processor, executing the computer instructions to implement the method for autonomous driving lane-keeping control.

One or more embodiments of the present disclosure provide a non-transitory computer-readable storage medium. The storage medium stores computer instructions. When a computer reads the computer instruction in the storage medium, the computer executes the method for autonomous driving lane-keeping control.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an application scenario of a system for autonomous driving lane-keeping control according to some embodiments of the present disclosure;

FIG. 2 is a block diagram illustrating a system for autonomous driving lane-keeping control according to some embodiments of the present disclosure;

FIG. 3 is a flowchart illustrating an exemplary process for autonomous driving lane-keeping control according to some embodiments of the present disclosure;

FIG. 4 is a flowchart illustrating an exemplary process of obtaining a deviation observation value of an ego vehicle relative to a lane centerline corresponding to a current moment according to some embodiments of the present disclosure;

FIG. 5 is a flowchart illustrating an exemplary process of switching a lane-keeping control mode according to some embodiments of the present disclosure;

FIG. 6 is a schematic diagram illustrating an exemplary detection cycle and control cycle according to some embodiments of the present disclosure;

FIG. 7 is a schematic diagram illustrating an exemplary deviation of an ego vehicle relative to a lane centerline according to some embodiments of the present disclosure; and

FIG. 8A and FIG. 8B are exemplary schematic diagrams illustrating generating a current path according to some embodiments of the present disclosure.

### DETAILED DESCRIPTION

To more clearly illustrate the technical solutions of the embodiments of the present disclosure, the drawings used in the description of the embodiments will be briefly introduced below. Obviously, the drawings in the following description are only some examples or embodiments of the present disclosure. For those of ordinary skill in the art, without creative effort, the present disclosure may be applied to other similar scenarios based on these drawings. Unless obvious from the context or otherwise stated, the same reference numbers in the figures denote the same structures or operations.

It is understood that the terms “system”, “device”, “unit” and/or “module” used herein are manners for distinguishing different components, elements, parts, sections or assemblies at different levels. However, if other words may achieve the same purpose, the words may be replaced by other expressions.

As shown in the present disclosure and the claims, unless the context clearly indicates an exception, the words “a”, “an”, “one” and/or “the” are not specifically singular and may also include the plural. Generally, the terms “include” and “comprise” only indicate the inclusion of clearly identified steps and elements, and these steps and elements do not constitute an exclusive list. The method or device may also include other steps or elements.

The present disclosure uses flowcharts to illustrate the operations performed by the system according to the embodiments of the present disclosure. It is understood that the preceding or following operations may not be performed exactly in sequence. Instead, the steps may be processed in reverse order or simultaneously. At the same time, other operations may also be added to these processes.

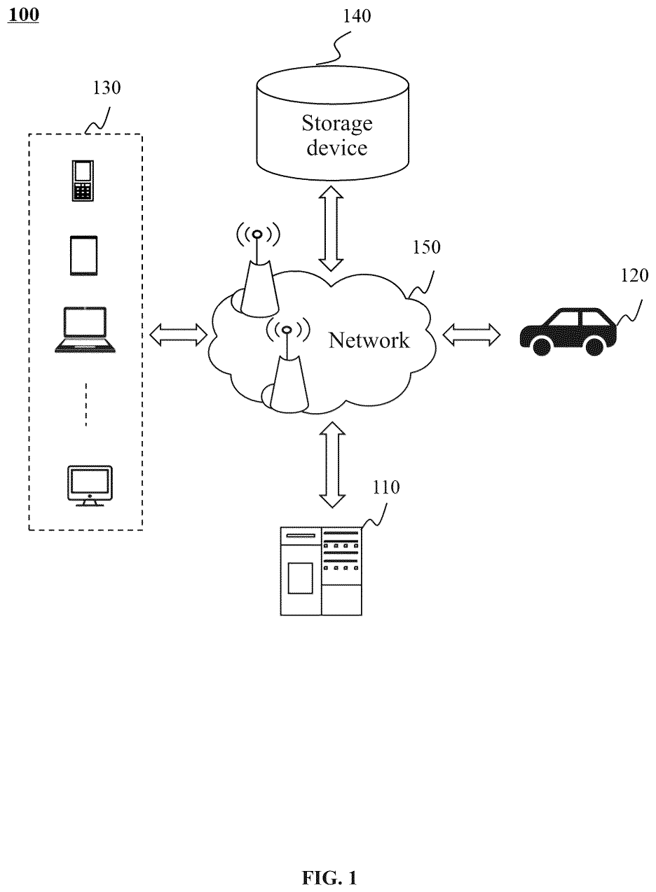

FIG. 1 is a schematic diagram illustrating an application scenario of a system for autonomous driving lane-keeping control according to some embodiments of the present disclosure. In some embodiments, an application scenario 100 of the system for autonomous driving lane-keeping control may include various autonomous driving scenarios, such as driving scenarios of private autonomous vehicles, shared autonomous vehicles, unmanned autonomous cargo vehicles, etc. In some embodiments, the application scenario 100 may achieve a high-precision lane-keeping function by implementing the manners and processes disclosed in the present disclosure.

In some embodiments, as shown in FIG. 1, the application scenario 100 may include a processing device 110, a vehicle 120, a terminal device 130, a storage device 140, and a network 150.

The processing device 110 is configured to process data and information from at least one component of the application scenario 100 or an external data source (e.g., a cloud data center). For example, the processing device 110 may, within a control cycle, obtain a deviation observation value of an ego vehicle relative to a lane centerline corresponding to a current moment based on a deviation of the ego vehicle relative to the lane centerline corresponding to a previous moment and a deviation observation value of the ego vehicle relative to the lane centerline corresponding to the previous moment. As another example, the processing device 110 may determine a lane centerline at a first preset distance (i.e., a first preset length) from a corrected ego vehicle position from an electronic map received from the first terminal device 130, as a lane centerline corresponding to the current moment. In some embodiments, the processing device 110 may include a central processing unit (CPU), a digital signal processor (DSP), a system on chip (SoC), a microcontroller unit (MCU), a computer, a user console, etc., or any combination thereof. In some embodiments, the processing device 110 may include a single server or a server group. The server group may be centralized or distributed. In some embodiments, the processing device 110 may be local or remote. In some embodiments, the processing device 110 may be implemented on a cloud platform. Merely by way of example, the cloud platform may include a private cloud, a public cloud, a hybrid cloud, a community cloud, a distributed cloud, an internal cloud, a multi-layer cloud, etc., or any combination thereof.

The ego vehicle 120 may be a transport service vehicle for the application scenario 100. In some embodiments, the ego vehicle 120 may include private autonomous vehicles, shared autonomous vehicles, unmanned autonomous cargo vehicles, etc. In some embodiments, the ego vehicle 120 may receive instructions issued by the processing device 110 and perform corresponding tasks according to the instructions. For example, the ego vehicle 120 may receive instructions such as entering a lane-keeping control mode, exiting the lane-keeping control mode, entering a conventional driving mode, controlling the ego vehicle to stop, etc., and automatically control the ego vehicle 120 to complete corresponding operations. In some embodiments, the ego vehicle 120 may include a positioning component (e.g., a GPS module), an image acquisition component (e.g., a camera), sensors (e.g., a radar sensor, an ultrasonic sensor, a laser sensor, an inertial measurement unit sensor), etc. In some embodiments, the ego vehicle 120 may communicate with the processing device 110 via the network 150. For example, the ego vehicle 120 may send an ego vehicle position corresponding to the current moment to the processing device 110 via the network 150.

The terminal device 130 may be a terminal device that displays the electronic map and vehicle paths. In some embodiments, the terminal device 130 may be installed on the ego vehicle 120 or may be a component of the ego vehicle 120. In some embodiments, the terminal device 130 may receive the electronic map, the ego vehicle paths, etc., from the processing device 110 via the network 150, and display them to a user through a screen. In some embodiments, the terminal device 130 may include a mobile device, a tablet computer, a laptop computer, other devices with input and/or output functions, etc., or any combination thereof.

The storage device 140 may be configured to store data, instructions, and any other information. For example, the storage device may store the deviation of the ego vehicle relative to the lane centerline corresponding to the previous moment, historical paths, etc. In some embodiments, the storage device may include random access memory (RAM), read-only memory (ROM), mass storage, removable memory, volatile read-write memory, etc., or any combination thereof. In some embodiments, the storage device may be integrated into or included in one or more other components of the application scenario 100, such as the processing device 110, the ego vehicle 120, or the terminal device 130.

The network 150 may facilitate the exchange of information and/or data. In some embodiments, one or more components of the application scenario 100 (e.g., the processing device 110, the ego vehicle 120, the terminal device 130, the storage device 140) may send information and/or data to other components of the application scenario 100 via the network 150. In some embodiments, the network 150 may include any one or more of a wired network or a wireless network. In some embodiments, the network 150 may include a cable network, a fiber optic network, a telecommunications network, the Internet, a local area network (LAN), a wide area network (WAN), a wireless local area network (WLAN), a metropolitan area network (MAN), a public switched telephone network (PSTN), a Bluetooth network, a ZigBee network, near field communication (NFC), intra-device bus, intra-device wiring, cable connections, etc., or any combination thereof. In some embodiments, the network connections between components of the application scenario 100 may adopt one or more of the above manners. In some embodiments, the network may have various topologies, such as point-to-point, shared, centralized, etc., or combinations of multiple topologies.

It is worth noting that the application scenario 100 is provided for illustrative purposes only and is not intended to limit the scope of the present disclosure. Those of ordinary skill in the art may make various changes and modifications based on the description of the present disclosure. For example, the application scenario 100 may also include databases, information sources, etc. As another example, the application scenario 100 may be implemented on other devices to achieve similar or different functions. However, these changes and modifications do not depart from the scope of the present disclosure.

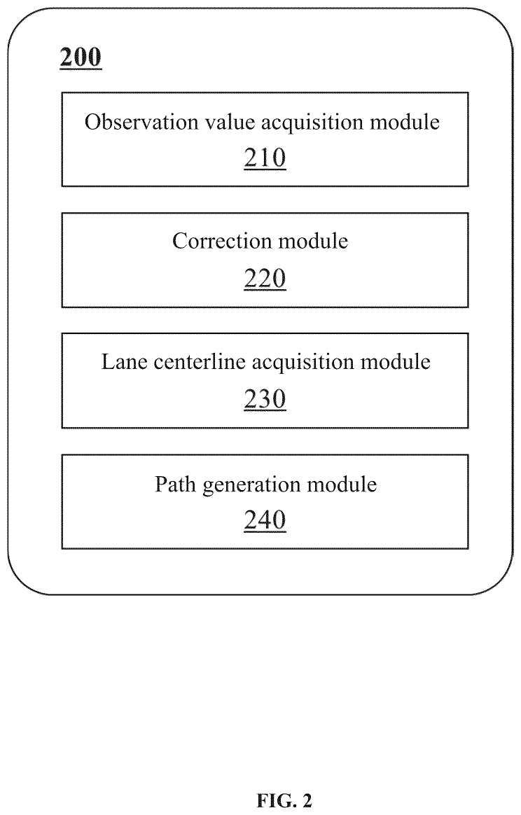

FIG. 2 is a block diagram illustrating a system for autonomous driving lane-keeping control according to some embodiments of the present disclosure. In some embodiments, a system 200 for autonomous driving lane-keeping control may be implemented by the processing device 110. In some embodiments, as shown in FIG. 2, the system 200 for autonomous driving lane-keeping control may include an observation value acquisition module 210, a correction module 220, a lane centerline acquisition module 230, and/or a path generation module 240.

The observation value acquisition module 210 is configured to, within a control cycle, obtain a deviation observation value of an ego vehicle relative to a lane centerline corresponding to a current moment, based on a deviation of the ego vehicle relative to the lane centerline corresponding to a previous moment and a deviation observation value of the ego vehicle relative to the lane centerline corresponding to the previous moment. In some embodiments, the deviation of the ego vehicle relative to the lane centerline corresponding to the previous moment is obtained based on a detection cycle. In some embodiments, the observation value acquisition module 210 may perform one or more of the following operations: based on a lateral velocity and a yaw rate change of the ego vehicle, obtaining an increment of the deviation of the ego vehicle relative to the lane centerline corresponding to the previous moment within the control cycle; based on the increment of the deviation of the ego vehicle relative to the lane centerline corresponding to the previous moment within the control cycle and the deviation observation value of the ego vehicle relative to the lane centerline corresponding to the previous moment, determining a deviation estimation of the ego vehicle relative to the lane centerline corresponding to the current moment; and through an observer, based on the deviation estimation of the ego vehicle relative to the lane centerline corresponding to the current moment, the deviation of the ego vehicle relative to the lane centerline corresponding to the previous moment, and the deviation observation value of the ego vehicle relative to the lane centerline corresponding to the previous moment, obtaining the deviation observation value of the ego vehicle relative to the lane centerline corresponding to the current moment. In some embodiments, the observation value acquisition module 210 may perform one or more of the following operations: obtaining a motion difference value between the deviation of the ego vehicle relative to the lane centerline corresponding to the previous moment and the deviation observation value of the ego vehicle relative to the lane centerline corresponding to the previous moment; based on the observer and the motion difference value, obtaining an observation calculation value corresponding to the previous moment; and based on the deviation estimation of the ego vehicle relative to the lane centerline corresponding to the current moment and the observation calculation value corresponding to the previous moment, obtaining the deviation observation value of the ego vehicle relative to the lane centerline corresponding to the current moment. In some embodiments, the observer is a diagonal matrix. In some embodiments, the diagonal matrix includes a first coefficient and a second coefficient, and the first coefficient and the second coefficient are greater than 0 and less than 1. In some embodiments, the first coefficient corresponds to a confidence level of the deviation of the ego vehicle relative to the lane centerline corresponding to the previous moment, and the second coefficient corresponds to a confidence level of the deviation observation value of the ego vehicle relative to the lane centerline corresponding to the previous moment. In some embodiments, at least one of the first coefficient and the second coefficient is determined based on ego vehicle environment information.

The correction module 220 is configured to correct an ego vehicle position corresponding to the current moment based on the deviation observation value of the ego vehicle relative to the lane centerline corresponding to the current moment.

The lane centerline acquisition module 230 is configured to obtain a lane centerline corresponding to the current moment based on the corrected ego vehicle position.

The path generation module 240 is configured to generate a current path based on the lane centerline corresponding to the current moment, and perform lane-keeping control based on the current path. In some embodiments, when entering a lane-keeping control mode for a first time, the current path is generated by curve-connecting the corrected ego vehicle position and the lane centerline corresponding to the current moment. In some embodiments, when entering the lane-keeping control mode not for the first time, the current path is generated by splicing a historical path with the lane centerline corresponding to the current moment. In some embodiments, the path generation module 240 may perform one or more of the following operations: determine whether a lane line detection result is valid and whether a deviation of the ego vehicle relative to the lane centerline detected within the detection cycle satisfies a first preset condition; in response to determining that the lane line detection result is valid and the deviation of the ego vehicle relative to the lane centerline detected within the detection cycle satisfies the first preset condition, determine the deviation observation value of the ego vehicle relative to the lane centerline corresponding to the current moment; and in response to determining that the lane line detection result is not valid or the deviation of the ego vehicle relative to the lane centerline detected within the detection cycle does not satisfy the first preset condition, exiting the lane-keeping control mode. In some embodiments, the path generation module 240 may perform one or more of the following operations: after exiting the lane-keeping control mode, determining whether a relative positional relationship between the ego vehicle and the lane centerline satisfies a second preset condition; in response to determining that the relative positional relationship does not satisfy the second preset condition, implementing parking; in response to determining that the relative positional relationship satisfies the second preset condition, entering a conventional control mode.

The current path refers to a driving path for the ego vehicle to perform the lane-keeping control.

It should be noted that the above description of the system 200 for autonomous driving lane-keeping control and its modules are for convenience of description only and does not limit the present disclosure to the scope of the cited embodiments. It is understood that for those skilled in the art, after understanding the principles of the device, they may arbitrarily combine various modules or form sub-devices to connect with other modules without departing from these principles. In some embodiments, the modules disclosed in FIG. 2 may be different modules in a system, or one module may implement the functions of two or more modules described above. For example, each module may share a storage module, or each module may have its own storage module. Such modifications are within the scope of protection of the present disclosure.

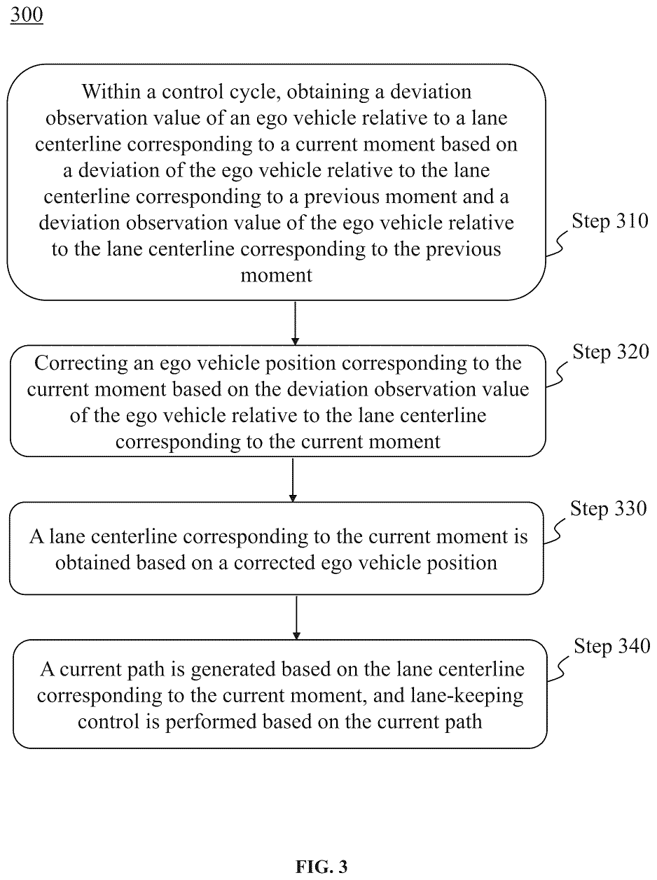

FIG. 3 is a flowchart illustrating an exemplary process for autonomous driving lane-keeping control according to some embodiments of the present disclosure. In some embodiments, a process 300 may be performed by the processing device 110 or the system 200 for autonomous driving lane-keeping control. For example, the process 300 may be stored in a storage device in the form of a program or an instruction. When the processing device 110 or the system 200 for autonomous driving lane-keeping control executes the instruction, the process 300 may be implemented. An operational schematic of the process 300 presented below is illustrative. In some embodiments, one or more additional operations not described and/or one or more operations not discussed may be utilized to complete the process. In addition, the order of the operations of the process 300 shown in FIG. 3 and described below is not limiting.

In 310, within a control cycle, a deviation observation value of an ego vehicle relative to a lane centerline corresponding to a current moment is obtained based on a deviation of the ego vehicle relative to the lane centerline corresponding to a previous moment and a deviation observation value of the ego vehicle relative to the lane centerline corresponding to the previous moment. In some embodiments, the operation 310 may be performed by the observation value acquisition module 210.

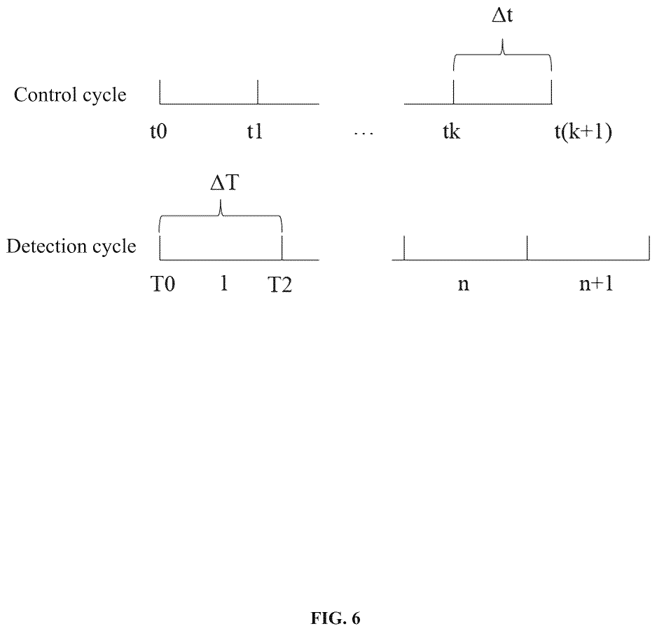

The control cycle refers to a cycle for correcting an ego vehicle position. That is, the current moment for correcting the ego vehicle position and the previous moment for correcting the ego vehicle position may be separated by one control cycle. For example, one control cycle is 25 milliseconds or 10 milliseconds. Merely by way of example, FIG. 6 is a schematic diagram illustrating an exemplary detection cycle and control cycle according to some embodiments of the present disclosure. As shown in FIG. 6, the control cycle is Δt. After correcting an ego vehicle position at a previous moment tk, an ego vehicle position at a current moment t(k+1)=tk+Δt needs to be corrected again.

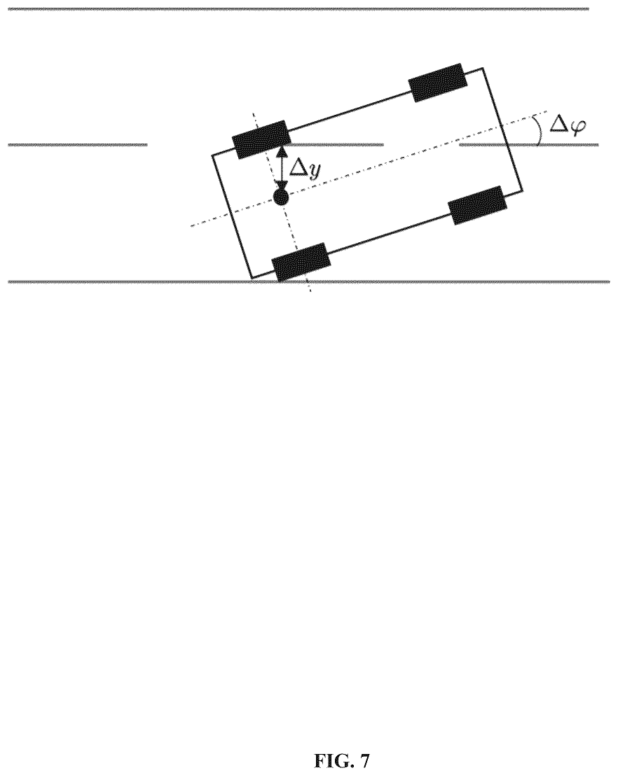

The deviation of the ego vehicle relative to the lane centerline refers to a deviation value between the ego vehicle and the lane centerline obtained through detection. In some embodiments, the deviation of the ego vehicle relative to the lane centerline may be represented by an ego vehicle angle deviation and an ego vehicle lateral deviation. The ego vehicle angle deviation may be an angle between a vertical axis of the ego vehicle and the lane centerline. The ego vehicle lateral deviation may be a distance from a midpoint of a rear axle center of the ego vehicle (i.e., an intersection of a rear wheel connecting line and the vertical axis of the ego vehicle) to the lane centerline. Merely by way of example, FIG. 7 is a schematic diagram illustrating an exemplary deviation of an ego vehicle relative to a lane centerline according to some embodiments of the present disclosure. As shown in FIG. 7, the ego vehicle angle deviation is Δφ, the ego vehicle lateral deviation is Δy, and the deviation of the ego vehicle relative to the lane centerline may be z=[Δφ, Δy].

In some embodiments, the observation value acquisition module 210 may first obtain an image of lane boundaries on both sides of a lane where a current position of the ego vehicle is located through a camera of the ego vehicle, determine a lane centerline position based on the image of the lane boundaries on both sides, and calculate the deviation of the ego vehicle relative to the lane centerline based on the lane centerline position and the current position of the ego vehicle.

In some embodiments, the deviation of the ego vehicle relative to the lane centerline corresponding to the previous moment is obtained based on a detection cycle. The detection cycle refers to a cycle for detecting the deviation of the ego vehicle relative to the lane centerline. That is, adjacent moments for detecting the deviation of the ego vehicle relative to the lane centerline may be separated by one detection cycle. For example, the detection cycle may be 100 milliseconds. Merely by way of example, as shown in FIG. 6, the detection cycle is ΔT, and adjacent moments T0 and T1 for detecting the deviation of the ego vehicle relative to the lane centerline are separated by the detection cycle ΔT (i.e., a first detection cycle).

In some embodiments, the deviation of the ego vehicle relative to the lane centerline at any moment within one detection cycle is the same, which is the deviation of the ego vehicle relative to the lane centerline detected at a first moment of the detection cycle. Merely by way of example, as shown in FIG. 6, the deviation of the ego vehicle relative to the lane centerline at any moment (e.g., t0 and t1) within the first detection cycle is equal to the deviation of the ego vehicle relative to the lane centerline detected at a first moment T0 of the first detection cycle, i.e., z(t0)=z(t1)=z(1)=z(T0).

In some embodiments, the observation value acquisition module 210 may determine a detection cycle corresponding to the previous moment, and determine the deviation of the ego vehicle relative to the lane centerline corresponding to the detection cycle corresponding to the previous moment as the deviation of the ego vehicle relative to the lane centerline corresponding to the previous moment. Merely by way of example, as shown in FIG. 6, the previous moment tk for correcting the ego vehicle position is within a n-th detection cycle, so the deviation of the ego vehicle relative to the lane centerline corresponding to the n-th detection cycle corresponding to the previous moment tk is taken as the deviation of the ego vehicle relative to the lane centerline corresponding to the previous moment tk, i.e., z(tk)=z(n).

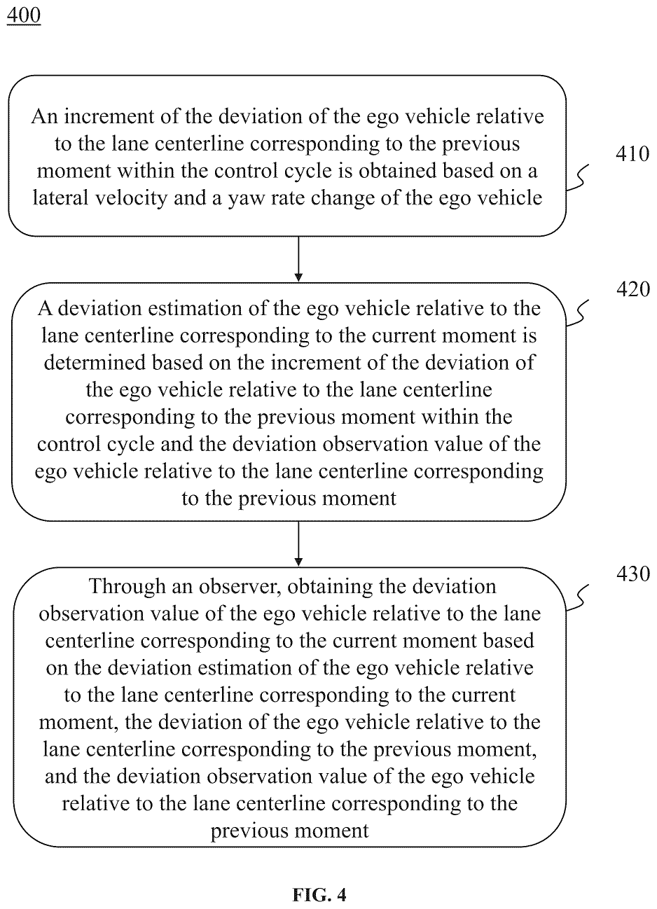

When the previous moment is a starting moment of the ego vehicle motion, the deviation observation value of the ego vehicle relative to the lane centerline corresponding to the previous moment is 0. For example, if the current moment is t1, then the deviation observation value of the ego vehicle relative to the lane centerline corresponding to the previous moment t0 is x̅(t0)=[0.0]. When the previous moment is a non-starting moment of the ego vehicle motion, the deviation observation value of the ego vehicle relative to the lane centerline corresponding to the previous moment may be obtained by referring to FIG. 4 and its related description. For example, if the current moment is t(k+1), then the deviation observation value \hat{x̅}(tk) of the ego vehicle relative to the lane centerline corresponding to the previous moment tk may be obtained based on an increment of a deviation of the ego vehicle relative to the lane centerline corresponding to a previous moment t(k−1) within the control cycle and the deviation observation value \overline{\hat{x}}(t (k−1)) of the ego vehicle relative to the lane centerline corresponding to the previous moment t(k−1).

The deviation observation value of the ego vehicle relative to the lane centerline corresponding to the current moment is a value used to correct the ego vehicle position at the current moment in a direction of the ego vehicle lateral deviation and a direction of the ego vehicle angle deviation, such as \hat{x}(t(k+1))=[ [symbol] (t(k+1)), [symbol] (t(k+1))]. Detailed description about obtaining the deviation observation value of the ego vehicle relative to the lane centerline corresponding to the current moment may be found in FIG. 4 and its related description, which will not be repeated here.

In 320, an ego vehicle position corresponding to the current moment is corrected based on the deviation observation value of the ego vehicle relative to the lane centerline corresponding to the current moment. In some embodiments, operation 320 may be performed by the correction module 220.

The ego vehicle position corresponding to the current moment may be a position of the ego vehicle in a world coordinate system at the current moment. In some embodiments, the correction module 220 may obtain the ego vehicle position at the current moment through a GPS module of the ego vehicle. For example, the ego vehicle position corresponding to the current moment is p(t(k+1)).

In some embodiments, the correction module 220 may convert the deviation observation value of the ego vehicle relative to the lane centerline corresponding to the current moment in a vehicle body coordinate system into a converted deviation observation value corresponding to the current moment in the world coordinate system, and then use the converted deviation observation value corresponding to the current moment to correct the ego vehicle position corresponding to the current moment, obtain a corrected ego vehicle position. For example, the deviation observation value \hat{x}(t(k+1)) in the vehicle body coordinate system is converted to a converted deviation observation value \hat{p}(t(k+1)) in the world coordinate system, and then after correcting the ego vehicle position corresponding to the current moment, obtain the corrected ego vehicle position in the world coordinate system: p′(t(k+1))=p(t(k+1))+\hat{p}(t(k+1)). By correcting the ego vehicle position, lane keeping can be better achieved even if satellite positioning causes jumps in the ego vehicle position due to signals.

It is known that there are two situations: the corrected ego vehicle position exceeds a safety boundary, and the corrected ego vehicle position does not exceed the safety boundary. In some embodiments, after obtaining the corrected ego vehicle position, the observation value acquisition module 210 may obtain environment boundary data; determine a safety boundary based on the environment boundary data and a safety buffer threshold; determine a critical deviation observation value of the ego vehicle relative to the lane centerline corresponding to the current moment based on the safety boundary; in response to the corrected ego vehicle position exceeding the safety boundary, adjust the deviation observation value of the ego vehicle relative to the lane centerline corresponding to the current moment to the critical deviation observation value.

The environment boundary data refers to data used to represent a lateral space margin of the ego vehicle on the road. In some embodiments, the environment boundary data includes a first obstacle distance and a second obstacle distance. The first obstacle distance refers to a horizontal distance between a left side of the ego vehicle and a nearest obstacle. The second obstacle distance refers to a horizontal distance between a right side of the ego vehicle and a nearest obstacle.

In some embodiments, the observation value acquisition module 210 may obtain the environment boundary data through an ultrasonic radar mounted on the ego vehicle.

The safety buffer threshold refers to a minimum safe distance between the ego vehicle and an obstacle reserved to prevent collision between the ego vehicle and the obstacle during lane-keeping control or position correction.

In some embodiments, the safety buffer threshold may be preset manually or set by the system by default, such as 0.5 m, etc.

In some embodiments, the observation value acquisition module 210 may determine the safety buffer threshold based on a vehicle state parameter and a scene characteristic.

The vehicle state parameter refers to a parameter used to reflect a current driving state of the ego vehicle, such as a longitudinal speed, a lateral acceleration, and a yaw rate of the ego vehicle, etc. In some embodiments, the observation value acquisition module 210 may obtain the vehicle state parameter in real-time through a lateral controller. The lateral controller refers to an algorithmic functional unit used to control the lateral motion of the ego vehicle. The lateral controller may include sensors such as an on-board wheel speed sensor, an inertial measurement unit, and a gyroscope.

The longitudinal speed refers to a driving speed of the ego vehicle along a forward direction, in m/s. The longitudinal speed may be obtained in real-time by the on-board wheel speed sensor.

The lateral acceleration refers to an acceleration of the ego vehicle in a direction perpendicular to the forward direction, in m/s². The lateral acceleration is obtained by the inertial measurement unit.

The yaw rate refers to an angular velocity of the ego vehicle rotating around the vertical axis of the ego vehicle, in rad/s, used to reflect a rate of change of a heading angle of the ego vehicle over time, obtained in real-time by the gyroscope.

The scene characteristic refers to a characteristic reflecting road morphology, an adhesion condition, and a passage width, such as a road curvature, a ground friction coefficient, and a road width, etc.

The ground friction coefficient refers to a parameter used to quantify a maximum friction capability between tires and the road surface. In some embodiments, the ground friction coefficient and road curvature may be directly obtained from system pre-stored data. The road width refers to an available driving width of a road where the ego vehicle is located. In some embodiments, the observation value acquisition module 210 may determine the road width based on an image captured by the camera through an existing detection algorithm.

The existing detection algorithm may be a detection algorithm with image recognition functions (such as being able to recognize a count of vehicles, the road width, etc.), such as YOLOv5 (You Only Look Once version 5), YOLOv8 (You Only Look Once version 8), BiSeNet (Bilateral Segmentation Network), etc.

In some embodiments, the observation value acquisition module 210 may determine the safety buffer threshold by querying a preset table based on the vehicle state parameter and the scene characteristic. The preset table contains a correspondence between the vehicle state parameter and the scene characteristic and the safety buffer threshold. The preset table may be manually preset. The correspondence may include: the longitudinal speed, the yaw rate, the road curvature, the road width are positively correlated with the safety buffer threshold, and the ground friction coefficient is negatively correlated with the safety buffer threshold.

In some embodiments of the present disclosure, by dynamically adjusting the safety buffer distance according to the vehicle state parameter and the scene characteristic, the safety and adaptive capability of lane-keeping control in complex scenes are improved.

The safety boundary refers to a limit boundary position that the ego vehicle is currently allowed to deviate laterally. In some embodiments, the safety boundary includes a first safety boundary and a second safety boundary.

The first safety boundary refers to a limit boundary position that the ego vehicle is currently allowed to deviate to a left side of a driving direction. The second safety boundary refers to a limit boundary position that the ego vehicle is currently allowed to deviate to a right side of the driving direction.

In some embodiments, the observation value acquisition module 210 may determine a difference between the first obstacle distance minus the safety buffer threshold as the first safety boundary, and determine a difference between the second obstacle distance minus the safety buffer threshold as the second safety boundary.

The critical deviation observation value of the ego vehicle relative to the lane centerline corresponding to the current moment refers to a maximum lateral deviation of the ego vehicle relative to the lane centerline calculated by the observation value acquisition module 210 based on the safety boundary at the current moment. The critical deviation observation value includes a left critical deviation observation value and a right critical deviation observation value. The left critical deviation observation value is a maximum allowable value for the ego vehicle to deviate to the left from the lane centerline. The right critical deviation observation value is a maximum allowable value for the ego vehicle to deviate to the right from the lane centerline.

In some embodiments, the observation value acquisition module 210 may calculate a lateral distance of the first safety boundary relative to the lane centerline and determine it as the left critical deviation observation value, and calculate a lateral distance of the second safety boundary relative to the lane centerline and determine it as the right critical deviation observation value.

The corrected ego vehicle position refers to a position after correcting the ego vehicle position according to the deviation observation value of the ego vehicle relative to the lane centerline corresponding to the current moment.

In some embodiments, for the two situations where the corrected ego vehicle position exceeds the safety boundary and the corrected ego vehicle position does not exceed the safety boundary, if the observation value acquisition module 210 judges that after the ego vehicle corrects its position according to the deviation observation value of the ego vehicle relative to the lane centerline corresponding to the current moment, the corrected ego vehicle position will cross the safety boundary, then it adjusts the deviation observation value of the ego vehicle relative to the lane centerline corresponding to the current moment to the critical deviation observation value; if the observation value acquisition module 210 judges that after the ego vehicle corrects its position according to the deviation observation value of the ego vehicle relative to the lane centerline corresponding to the current moment, the corrected ego vehicle position will not cross the safety boundary, then it does not intervene in the adjustment of the ego vehicle position correction.

In some embodiments of the present disclosure, by limiting the ego vehicle position deviation correction result within the safety boundary, collisions caused by excessive correction are prevented, significantly improving the safety and robustness of lane-keeping control.

In 330, a lane centerline corresponding to the current moment is obtained based on a corrected ego vehicle position. In some embodiments, operation 330 may be performed by the lane centerline acquisition module 230.

In some embodiments, the lane centerline acquisition module 230 may determine a lane centerline at a first preset distance from the corrected ego vehicle position from the electronic map, as the lane centerline corresponding to the current moment. The first preset distance may be a distance preset manually, such as 50 m.

In 340, a current path is generated based on the lane centerline corresponding to the current moment, and lane-keeping control is performed based on the current path. In some embodiments, operation 340 may be performed by the path generation module 240.

In some embodiments, when entering a lane-keeping control mode for a first time, the current path is generated by curve-connecting the corrected ego vehicle position and the lane centerline corresponding to the current moment. In some embodiments, the path generation module 240 may first determine a point at a second preset distance from the corrected ego vehicle position on the electronic map, then use a curve to connect the point and a point on the lane centerline to generate the current path. The second preset distance may be a length preset manually. The second preset distance is less than the first preset distance, such as 20 m.

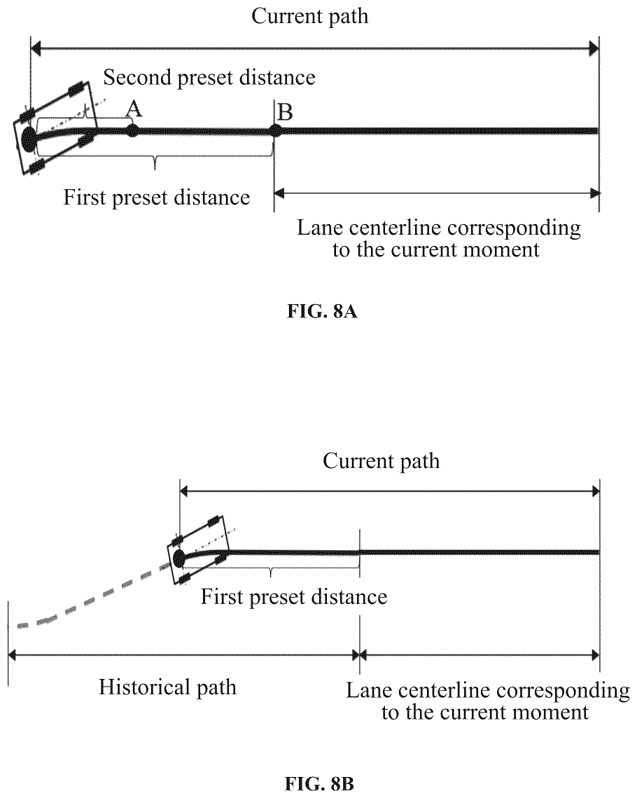

Merely by way of example, FIG. 8A and FIG. 8B are exemplary schematic diagrams of generating a current path according to some embodiments of the present disclosure. As shown in FIG. 8A, the ego vehicle enters the lane-keeping control mode for the first time. The path generation module 240 may first determine a point A at a distance of 20 m from the corrected ego vehicle position on the electronic map, then use a Dubin curve to connect the point A and a point B on the lane centerline corresponding to the current moment to generate the current path.

In some embodiments, when entering the lane-keeping control mode not for the first time, the current path is generated by splicing a historical path with the lane centerline corresponding to the current moment. The historical path may be a path generated at the previous moment. In some embodiments, the path generation module 240 may first intercept the historical path from the corrected ego vehicle position on the electronic map, then splice the historical path with the lane centerline corresponding to the current moment into the current path. Merely by way of example, as shown in FIG. 8B, the vehicle enters the lane-keeping control mode not for the first time. The path generation module 240 may intercept the historical path of the first preset distance from the corrected ego vehicle position on the electronic map, then splice an intercepted historical path of the first preset distance with the lane centerline corresponding to the current moment into the current path.

To prevent point jumps on the current path, in some embodiments, the path generation module 240 may smooth the current path through a smoothing algorithm.

In some embodiments of the present disclosure, by splicing the lane centerline corresponding to the current moment based on the corrected ego vehicle position to generate the current path, point jumps on the current path can be prevented.

The lane-keeping control mode is an assisted autonomous driving mode that tracks the current path through a lateral controller. In some embodiments, the path generation module 240 may convert the current path in the world coordinate system to a current vehicle body path in the vehicle body coordinate system, then input the current vehicle body path into the lateral controller of the ego vehicle, thereby controlling the vehicle to perform lane-keeping control through the lateral controller.

In some embodiments, the path generation module 240 may generate the current vehicle body path based on the current path; based on the current vehicle body path, generate a target steering angle of the ego vehicle through the lateral controller, and send the target steering angle to a vehicle steering system. The vehicle steering system may generate a target steering torque based on the target steering angle, and drive a steering motor to steer based on the target steering torque, to achieve lane-keeping control of the ego vehicle through the lateral controller.

More description about the lateral controller may be found in the related description of step 320 in FIG. 3.

More description about the current path may be found in the related description of FIG. 2.

In some embodiments, the path generation module 240 may convert the current path in the world coordinate system to the current vehicle body path in the vehicle body coordinate system through a preset coordinate conversion algorithm.

The target steering angle refers to a steering angle that makes the driving path and the driving direction of the ego vehicle both conform to the current path.

The vehicle steering system refers to a hardware execution mechanism that performs the vehicle steering action, including a plurality of components such as a steering wheel, a steering column, a steering gear, a steering motor, and a steering electronic control unit.

In some embodiments, the path generation module 240 may, through the lateral controller: obtain the vehicle state parameter of the ego vehicle in real-time; determine a tracking error of the ego vehicle relative to the current vehicle body path based on the current vehicle body path; based on the tracking error and the vehicle state parameter, through a preset lateral control algorithm, to minimize the tracking error, generate the target steering angle of the ego vehicle at the current moment.

The tracking error includes a lateral position error and a heading angle deviation. The lateral position error refers to a vertical distance from a mass center of the ego vehicle to the current vehicle body path. The heading angle deviation refers to an angle between a heading direction of the ego vehicle and a tangent direction of the current vehicle body path. In some embodiments, the tracking error may be directly calculated by the lateral controller based on relevant data obtained by the sensors (e.g., the camera, the inertial measurement unit, the GPS module, etc.) and the current vehicle body path. The relevant data may be the heading direction of the ego vehicle in the vehicle body coordinate system, etc. More descriptions about vehicle state parameters may be found in the related description in step 320.

The lateral control algorithm may be a Linear Quadratic Regulator (LQR), etc.

The target steering torque refers to a torque required to make the ego vehicle reach and maintain the target steering angle.

In some embodiments, the vehicle steering system may obtain a current actual steering angle of the steering motor in real-time through the sensors, calculate a difference between the target steering angle and the current actual steering angle, and determine the target steering torque required to eliminate the difference through a position closed-loop feedback control algorithm.

The position closed-loop algorithm may be a PID (Proportional-Integral-Derivative Controller) algorithm, etc.

In some embodiments of the present disclosure, through the collaborative work of the lateral controller and the vehicle steering system, a closed-loop control system is constructed, ensuring the precision of lane-keeping control and improving the real-time performance and reliability of lane-keeping control.

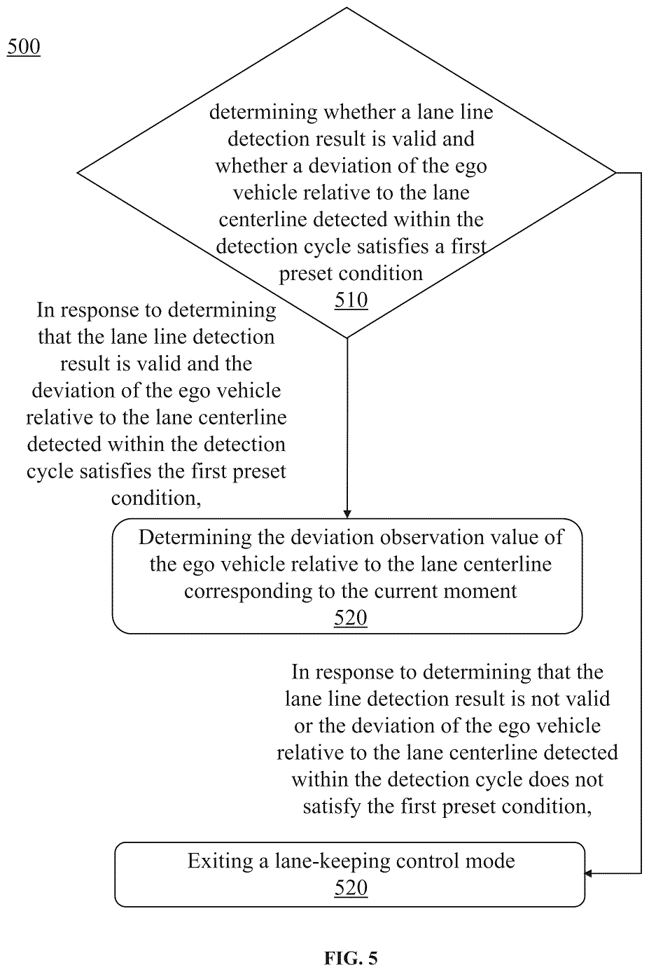

In some embodiments, before entering the lane-keeping control mode, the path generation module 240 may first determine whether the vehicle enters the lane-keeping control mode. A detailed description of determining whether the ego vehicle enters the lane-keeping control mode may be found in FIG. 5 and its related description, which will not be repeated here. It should be noted that the above description of the process 300 is provided for illustrative purposes only and is not intended to limit the scope of the present disclosure. Those of ordinary skill in the art may make various changes and modifications based on the description of the present disclosure. However, these changes and modifications do not depart from the scope of the present disclosure. In some embodiments, the process 300 may include one or more additional operations, or may omit one or more of the above operations.

In some embodiments of the present disclosure, by correcting the ego vehicle position corresponding to the current moment according to the deviation observation value corresponding to the current moment, and generating a path in combination with the lane centerline obtained from the electronic map, a high-precision lane-keeping function is achieved.

FIG. 4 is a flowchart illustrating an exemplary process of obtaining a deviation observation value of an ego vehicle relative to a lane centerline corresponding to a current moment according to some embodiments of the present disclosure. In some embodiments, a process 400 may be performed by the processing device 110 or the system 200 for autonomous driving lane-keeping control. For example, the process 400 may be stored in a storage device in the form of a program or an instruction. When the processing device 110 or the system 200 for autonomous driving lane-keeping control executes the instruction, the process 300 may be implemented. An operational schematic of the process 400 presented below is illustrative. In some embodiments, one or more additional operations not described and/or one or more operations not discussed may be utilized to complete the process. In addition, the order of the operations of the process 400 shown in FIG. 4 and described below is not limiting.

In 410, an increment of the deviation of the ego vehicle relative to the lane centerline corresponding to the previous moment within the control cycle is obtained based on a lateral velocity and a yaw rate change of the ego vehicle.

The lateral velocity of the ego vehicle is a movement speed of the ego vehicle in the direction of the ego vehicle lateral deviation at the previous moment, such as v_{y}(tk). The yaw rate change of the ego vehicle is a rotational speed of the ego vehicle in the direction of the ego vehicle angle deviation at the previous moment, such as ω(tk).

The increment of the deviation of the ego vehicle relative to the lane centerline corresponding to the previous moment within the control cycle includes an increment of the ego vehicle lateral deviation within the control cycle and an increment of the ego vehicle angle deviation within the control cycle. The increment of the ego vehicle lateral deviation within the control cycle is a movement length of the ego vehicle in the direction of the ego vehicle lateral deviation within a control cycle from the previous moment to the current moment. The increment of the ego vehicle angle deviation within the control cycle is a rotation angle of the ego vehicle in the direction of the ego vehicle angle deviation within the control cycle from the previous moment to the current moment.

In some embodiments, the observation value acquisition module 210 may obtain the increment of the ego vehicle lateral deviation relative to the lane centerline corresponding to the previous moment within the control cycle based on the lateral velocity of the ego vehicle and a time length of the control cycle; obtain the increment of the ego vehicle angle deviation relative to the lane centerline corresponding to the previous moment within the control cycle based on the yaw rate change of the ego vehicle and the time length of the control cycle. In some embodiments, the observation value acquisition module 210 may obtain the increment of the deviation of the ego vehicle relative to the lane centerline corresponding to the previous moment within the control cycle through formula (1).

$$μ ( tk ) = [ {v}_{y} ( tk ) * Δ t , ω ( tk ) * Δ t ] \qquad ( 1 )$$

Where, tk is the previous moment, v_{y}(tk) is a lateral velocity of the ego vehicle corresponding to the previous moment tk, ω(tk) is a yaw rate change of the ego vehicle corresponding to the previous moment tk, Δt is the time length of the control cycle, and μ(tk) is the increment of the deviation of the ego vehicle relative to the lane centerline corresponding to the previous moment within the control cycle.

In 420, a deviation estimation of the ego vehicle relative to the lane centerline corresponding to the current moment is determined based on the increment of the deviation of the ego vehicle relative to the lane centerline corresponding to the previous moment within the control cycle and the deviation observation value of the ego vehicle relative to the lane centerline corresponding to the previous moment.

The deviation estimation of the ego vehicle relative to the lane centerline corresponding to the current moment is the deviation value of the ego vehicle relative to the lane centerline corresponding to the current moment obtained through calculation. In some embodiments, the observation value acquisition module 210 may calculate the deviation estimation of the ego vehicle relative to the lane centerline corresponding to the current moment based on a sum of the increment of the deviation of the ego vehicle relative to the lane centerline corresponding to the previous moment within the control cycle and the deviation observation value of the ego vehicle relative to the lane centerline corresponding to the previous moment. In some embodiments, the observation value acquisition module 210 may calculate the deviation estimation of the ego vehicle relative to the lane centerline corresponding to the current moment through formula (2).

$$\overline{x} ( t ( k + 1 ) ) = \hat{x} ( tk ) + μ ( tk ) \qquad ( 2 )$$

Where, tk is the previous moment, t(k+1) is the current moment, \hat{x}(tk) is a deviation observation value of the ego vehicle relative to the lane centerline corresponding to the previous moment tk, μ(tk) is an increment of the deviation of the ego vehicle relative to the lane centerline corresponding to the previous moment tk within the control cycle, and x̅(t(k+1)) is a deviation estimation of the ego vehicle relative to the lane centerline corresponding to the current moment t(k+1).

In 430, through an observer, the deviation observation value of the ego vehicle relative to the lane centerline corresponding to the current moment is obtained based on the deviation estimation of the ego vehicle relative to the lane centerline corresponding to the current moment, the deviation of the ego vehicle relative to the lane centerline corresponding to the previous moment, and the deviation observation value of the ego vehicle relative to the lane centerline corresponding to the previous moment.

In some embodiments, the observation value acquisition module 210 may obtain a motion difference value between the deviation of the ego vehicle relative to the lane centerline corresponding to the previous moment and the deviation observation value of the ego vehicle relative to the lane centerline corresponding to the previous moment. The motion difference value between the deviation of the ego vehicle relative to the lane centerline corresponding to the previous moment and the deviation observation value of the ego vehicle relative to the lane centerline corresponding to the previous moment may reflect a difference between the deviations of the ego vehicle relative to the lane centerline corresponding to the previous moment obtained through detection and calculation, respectively.

In some embodiments, the observation value acquisition module 210 may obtain an observation calculation value corresponding to the previous moment based on the observer and the motion difference value.

The observer may be a matrix used to observe the motion difference value, i.e., a matrix that allocates confidence levels to the deviations of the ego vehicle relative to the lane centerline corresponding to the previous moment obtained through detection and calculation, respectively. In some embodiments, the observer is a diagonal matrix, and the diagonal matrix may include a first coefficient and a second coefficient. In some embodiments, the first coefficient and the second coefficient are greater than 0 and less than 1. Merely by way of example, the observer may be a Luenberger linear observer.

In some embodiments, the first coefficient corresponds to a confidence level of the deviation of the ego vehicle relative to the lane centerline corresponding to the previous moment, and the second coefficient corresponds to a confidence level of the deviation observation value of the ego vehicle relative to the lane centerline corresponding to the previous moment. It may be understood that the larger the first coefficient, the higher the confidence level of the observer in the deviation value of the ego vehicle relative to the lane centerline obtained through detection; the larger the second coefficient, the higher the confidence level of the observer in the deviation value of the ego vehicle relative to the lane centerline obtained through calculation.

In some embodiments, at least one of the first coefficient and the second coefficient is determined based on ego vehicle environment information. The ego vehicle environment information is information reflecting the current driving environment of the ego vehicle. In some embodiments, the ego vehicle environment information may include, but is not limited to, weather information, road condition information, and time information.

The weather information may indicate the weather when the ego vehicle is driving, such as sunny, rainy, or foggy. When the weather is sunny, the detection accuracy is high, so the first coefficient is larger, and the observer has higher confidence level in the deviation value of the ego vehicle relative to the lane centerline obtained through detection; when the weather is rainy or foggy, the detection accuracy is low, so the second coefficient is larger, and the observer has higher confidence level in the deviation value of the ego vehicle relative to the lane centerline obtained through calculation.

The road condition information may reflect marking information on the road where the ego vehicle is located (e.g., whether lane boundaries are clear, whether the lane boundaries are obscured) and road surface smoothness information (e.g., whether the road surface is smooth). When road markings are unclear or the road surface is uneven, the detection accuracy is low, so the second coefficient is larger, and the observer has higher confidence level in the deviation value of the ego vehicle relative to the lane centerline obtained through calculation. When the road markings are clear and the road surface is smooth, the detection accuracy is high, so the first coefficient is larger, and the observer has higher confidence level in the deviation value of the ego vehicle relative to the lane centerline obtained through detection.

The time information may reflect whether the road is during peak traffic hours when the ego vehicle is driving. During the peak traffic hours, the road is crowded, and detection accuracy is low, so the second coefficient is larger, and the observer has higher confidence level in the deviation value of the ego vehicle relative to the lane centerline obtained through calculation. During off-peak traffic hours, the road is not crowded, and detection accuracy is high, so the first coefficient is larger, and the observer has higher confidence level in the deviation value of the ego vehicle relative to the lane centerline obtained through detection.

In some embodiments, the observation value acquisition module 210 may determine the first coefficient and the second coefficient through an observer model. In some embodiments, the observation value acquisition module 210 may fuse the input ego vehicle environment information into a vector and map the vector to the first coefficient and the second coefficient. In some embodiments, the observer model may include but is not limited to a support vector machine model, a Logistic regression model, a naive Bayes classification model, a Gaussian distribution Bayes classification model, a decision tree model, a random forest model, a K-Nearest Neighbors (KNN) classification model, a neural network model, etc.

In some embodiments of the present disclosure, the observer determines the first coefficient and the second coefficient based on the ego vehicle environment information, then determines the confidence levels of the deviation values of the ego vehicle relative to the lane centerline corresponding to the previous moment obtained through detection and calculation based on the first coefficient and the second coefficient, so that the motion calculation value corresponding to the previous moment obtained based on the observer can change based on changes in the ego vehicle environment, thereby achieving autonomous driving lane keeping in different environments.

In some embodiments, the method for autonomous driving lane-keeping control further includes adjusting the first coefficient and the second coefficient at every preset interval. In some embodiments, at every preset cycle, the observation value acquisition module 210 may adjust the first coefficient and the second coefficient based on an environmental interference characteristic, an observation quality characteristic, and a scene complexity characteristic.

The preset cycle refers to a preset time interval for adjusting the first coefficient and the second coefficient. In some embodiments, the preset cycle may be preset manually or set by the system by default. For example, the preset cycle may be 5 minutes, etc.

The environmental interference characteristic refers to an external environmental factor that causes physical interference to the perception capability of the sensors. For example, the environmental interference characteristic may include an environmental visibility, an environmental illumination intensity, and a rainfall intensity, etc.

The environmental visibility refers to a visibility of an environment around the ego vehicle. In some embodiments, the observation value acquisition module 210 may obtain a plurality of images of the environment around the ego vehicle through the camera of the ego vehicle, calculate an image transmittance of each of the plurality of images based on a dark channel prior algorithm, and determine an average of the image transmittances of the plurality of images as the environmental visibility.

The environmental illumination intensity refers to a brightness value of the environment around the ego vehicle. In some embodiments, the observation value acquisition module 210 may directly obtain the environmental illumination intensity through a light sensor installed on the windshield of the ego vehicle.

The rainfall intensity may be represented by precipitation per unit time. In some embodiments, the observation value acquisition module 210 may obtain the rainfall intensity from a third-party meteorological service.

The observation quality characteristic refers to an indicator for evaluating the acquisition stability and the reliability of a recognition result of sensor observation data (such as images acquired by the camera). For example, the observation quality characteristic may include a lane line detection confidence, a road surface high-frequency vibration level, and an image contrast, etc.

The lane line detection confidence refers to a reliability degree of a lane line detection result. In some embodiments, the observation value acquisition module 210 may obtain a lane line image of the lane where the current position of the ego vehicle is located through the camera of the ego vehicle, input the lane line image into an existing image recognition model to obtain a plurality of lane line coordinate points and a confidence of each of the plurality of lane line coordinate points, and determine an average of the confidences of the plurality of lane line coordinate points as the lane line detection confidence. The confidence of the lane line coordinate point indicates a probability that the lane line coordinate point output by the existing image recognition model is a true position point on the lane line. The higher the lane line detection confidence, the higher the acquisition stability and the recognition result reliability when the camera acquires images. The existing image recognition model may be Ultra-Fast-Lane-Detection (UFLD), etc.

The road surface high-frequency vibration level refers to a vibration level reflecting the vibration of the camera due to road bumps, which may be represented by a variance of plurality of acceleration data along a vertical direction (Z-axis) of the own coordinate system of the inertial measurement unit obtained by an inertial measurement unit installed around the camera. The higher the road surface high-frequency vibration level, the bumpier the road surface, and the lower the acquisition stability and the recognition result reliability when the camera acquires images.

The image contrast may be represented by a standard deviation of an image grayscale histogram of a road surface area in the image of the lane boundaries on both sides of the lane where the current position of the ego vehicle is located acquired by the camera, used to reflect whether the road texture is clear, whether there is water accumulation reflection or shadow coverage on the road surface, or whether there is lens contamination on the camera, etc. In some embodiments, if the image contrast is lower than a contrast threshold, it indicates that the road texture is not clear, there is water accumulation reflection or shadow coverage on the road surface, or there is lens contamination on the camera, etc. The contrast threshold may be preset by technical personnel according to requirements. If the image contrast exceeds the contrast threshold and the higher the image contrast, the higher the acquisition stability and the recognition result reliability when the camera acquires images.

The scene complexity characteristic refers to a characteristic reflecting the complexity of the driving environment of the ego vehicle. For example, the scene complexity characteristic may include a count of vehicles within a current field of view, a percentage of lane line occluded by vehicles ahead, and a congestion probability during a current time period, etc.

The count of vehicles within the current field of view refers to a count of vehicles within an observation range of the camera of the ego vehicle. In some embodiments, the observation value acquisition module 210 may determine the count of vehicles within the current field of view based on the existing detection algorithm.

More descriptions about the existing detection algorithm may be found in the related description of operation 320 in FIG. 3.

The percentage of lane line occluded by vehicles ahead refers to a proportion of a lane line length that is invisible due to being covered by the vehicles ahead in the image of the lane boundaries on both sides to a standard lane line length. The standard lane line length may refer to a lane line length when there is no vehicle occlusion. The lane line length may be a sum of the lengths of the lane lines on both sides.

The congestion probability during the current time period may be obtained by the observation value acquisition module 210 based on historical data from the same time period as the current time period.

For example, if the current time period is 08:00-08:30, and the historical data shows that in the past m days, there were n days with congestion during 08:00-08:30, then the congestion probability for the current time period may be determined as n/m. Whether congestion occurred may be calibrated by a third-party platform (such as Amap).

In some embodiments, the observation value acquisition module 210 may obtain, through vector database matching, a first coefficient and a second coefficient that minimize the deviation of the ego vehicle relative to the lane centerline, replace a previous first coefficient and a previous second coefficient, and determine the first coefficient and the second coefficient that minimize the deviation of the ego vehicle relative to the lane centerline as the first coefficient and second coefficient for a next preset cycle.

In some embodiments, the observation value acquisition module 210 may select a large amount of historical real-vehicle driving records containing different scenes (e.g., different weather, different environments, or different traffic conditions, etc.) from the historical data; for each historical real-vehicle driving record, construct a simulation scene according to its corresponding historical sensor data and historical vehicle trajectory data, and conduct a plurality of simulation experiments according to a plurality of candidate coefficient combinations, each of the plurality of candidate coefficient combination including a candidate first coefficient and a candidate second coefficient; construct a historical environmental interference characteristic, a historical observation quality characteristic, and a historical scene complexity characteristic corresponding to the historical real-vehicle driving record into a reference feature vector; determine a candidate coefficient combination corresponding to a smallest deviation of the ego vehicle relative to the lane centerline among the plurality of simulation experiments corresponding to the historical real-vehicle driving record as a reference coefficient combination corresponding to the reference feature vector; the plurality of reference feature vectors and a plurality of reference coefficient combinations corresponding the plurality of reference feature vectors constitute a vector database. When querying the vector database, the observation value acquisition module 210 generates a query feature vector based on a current environmental interference characteristic, a current observation quality characteristic, and a current scene complexity characteristic, inputs the query feature vector into the vector database, retrieves a reference feature vector with the highest similarity to the query feature vector, and determines a reference coefficient combination corresponding the reference feature vector with the highest similarity to the query feature vector as the first coefficient and the second coefficient for the next preset cycle.

In some embodiments, the observation value acquisition module 210 may generate the plurality of candidate coefficient combinations corresponding to the reference feature vector based on the reference feature vector according to a preset correlation. The preset correlation may be manually preset. For example, the smaller the environmental visibility in the environmental interference characteristic, the lower the lane line detection confidence in the observation quality characteristic, and the greater the count of vehicles within the current field of view in the scene complexity characteristic, indicating that the accuracy or reliability of the sensor observation data is smaller, so the dependence on sensor observation data should be reduced. Then, the first coefficient is smaller, and the second coefficient is larger.

In some embodiments of the present disclosure, by dynamically adjusting the first coefficient and the second coefficient, the system can adapt to changes in different scenes and environments in real time, improving the accuracy of lane-keeping control, thereby enhancing the reliability and safety of the autonomous driving system in complex driving environments.

The observation calculation value corresponding to the previous moment may be a deviation correction of the ego vehicle relative to the lane centerline calculated after observing the motion difference value corresponding to the previous moment.

In some embodiments, the observation value acquisition module 210 may obtain the motion calculation value corresponding to the previous moment through formula (3).

$$H ( tk ) = G * ( z ( tk ) - \hat{x} ( tk ) ) \qquad ( 3 )$$

Where, tk is the previous moment, z(tk)−\hat{x}(tk) is a motion difference value corresponding to the previous moment tk, G is the observer, and H(tk) is a motion calculation value corresponding to the previous moment tk.

In some embodiments, the observation value acquisition module 210 may obtain the deviation observation value of the ego vehicle relative to the lane centerline corresponding to the current moment based on the deviation estimation of the ego vehicle relative to the lane centerline corresponding to the current moment and the motion calculation value corresponding to the previous moment.

In some embodiments, the observation value acquisition module 210 may obtain the deviation observation value of the ego vehicle relative to the lane centerline corresponding to the current moment through formula (4).

$$\hat{x} ( t ( k + 1 ) ) = \overline{x} ( t ( k + 1 ) ) + H ( tk ) \qquad ( 4 )$$

Where, tk is the previous moment, t(k+1) is the current moment, \hat{x}(t(k+1)) is a deviation observation value of the ego vehicle relative to the lane centerline corresponding to the current moment t(k+1), x̅(t(k+1)) is a deviation estimation of the ego vehicle relative to the lane centerline corresponding to the current moment t(k+1), and H(tk) is a motion calculation value corresponding to the previous moment tk.

In some embodiments of the present disclosure, by using the observer to observe the deviation estimations of the ego vehicle relative to the lane centerline obtained through detection and calculation, when the detection cycle and the control cycle are inconsistent leading to low trust in the deviation estimation of the ego vehicle relative to the lane centerline obtained through detection, it can further rely on the deviation estimation of the ego vehicle relative to the lane centerline obtained through calculation to determine the motion calculation value corresponding to the previous moment, thereby improving the control accuracy of lane keeping.

It should be noted that the above description of the process 400 is provided for illustrative purposes only and is not intended to limit the scope of the present disclosure. Those of ordinary skill in the art may make various changes and modifications based on the description of the present disclosure. However, these changes and modifications do not depart from the scope of the present disclosure. In some embodiments, the process 400 may include one or more additional operations, or may omit one or more of the above operations.

In some embodiments of the present disclosure, by obtaining the deviation observation value of the ego vehicle relative to the lane centerline corresponding to the current moment based on the deviation estimation of the ego vehicle relative to the lane centerline corresponding to the current moment and the motion calculation value corresponding to the previous moment obtained through the observer, the deviation estimation of the ego vehicle relative to the lane centerline corresponding to the current moment obtained through inspection can be corrected by the observer, solving the error caused by the inconsistency between the detection cycle and the control cycle, thereby improving the control accuracy of lane keeping.

FIG. 5 is a flowchart illustrating an exemplary process of switching a lane-keeping control mode according to some embodiments of the present disclosure. In some embodiments, a process 500 may be performed by the processing device 110 or the system 200 (e.g., the path generation module 240) for autonomous driving lane-keeping control. For example, the process 500 may be stored in a storage device in the form of a program or an instruction. When the processing device 110 or the system 200 (e.g., the path generation module 240) for autonomous driving lane-keeping control executes the instruction, the process 500 may be implemented. An operational schematic of the process 500 presented below is illustrative. In some embodiments, one or more additional operations not described and/or one or more operations not discussed may be utilized to complete the process. In addition, the order of the operations of the process 500 shown in FIG. 5 and described below is not limiting.

In 510, it is determined whether a lane line detection result is valid and whether a deviation of the ego vehicle relative to the lane centerline detected within the detection cycle satisfies a first preset condition.

The lane line detection result may be the image of the lane boundaries on both sides of the lane where the current position of the ego vehicle is located. Related description about obtaining the lane line detection result may be found in operation 310 and will not be repeated here. In some embodiments, the path generation module 240 may identify whether the lane boundaries on both sides in the image are missing, damaged, occluded, etc., through an image recognition model. If the lane boundaries on both sides in the image are missing, damaged, occluded, etc., it determines that the lane line detection result is invalid; if the lane boundaries on both sides in the image are not missing, damaged, occluded, etc., it is valid.

The first preset condition refers to a condition for judging whether the deviation of the ego vehicle relative to the lane centerline detected within the detection cycle safely enters the lane-keeping control mode. The first preset condition may be a condition preset manually. For example, the first preset condition may be an ego vehicle angle deviation Δφ is less than or equal to 5° and an ego vehicle lateral deviation Δy is less than or equal to 5 m.

In 520, in response to determining that the lane line detection result is valid and the deviation of the ego vehicle relative to the lane centerline detected within the detection cycle satisfies the first preset condition, the deviation observation value of the ego vehicle relative to the lane centerline corresponding to the current moment is determined, and in response to determining that the lane line detection result is not valid or the deviation of the ego vehicle relative to the lane centerline detected within the detection cycle does not satisfy the first preset condition, a lane-keeping control mode is exited. Detailed description about determining the deviation observation value corresponding to the current moment may be found in step 310 and will not be repeated here. Merely by way of example, if the lane line detection result at the current moment t(k+1) is valid, and Δφ(t(k+1)) is equal to 3°, being less than 5°, Δy(t(k+1)) is equal to 3 m, being less than 5 m, then the deviation observation value \hat{x}(t(k+1)) corresponding to the current moment t(k+1) may be determined.

In some embodiments, the path generation module 240, after exiting the lane-keeping control mode, determines whether a relative positional relationship between the ego vehicle and the lane centerline satisfies a second preset condition. The second preset condition refers to a condition for judging whether the current relative positional relationship between the ego vehicle and the lane centerline safely enters a conventional control mode. The second preset condition may be a condition preset manually. For example, the second preset condition may be the ego vehicle angle deviation Δφ is less than or equal to 2° and the ego vehicle lateral deviation Δy is less than or equal to 2 m.

In some embodiments, the path generation module 240, in response to determining that the relative positional relationship does not satisfy the second preset condition, implements parking. Merely by way of example, if Δφ(t(k+1)) is equal to 3°, being greater than 2°, and Δy(t(k+1)) is equal to 3 m, being greater than 2 m, the path generation module 240 then implements parking.

It is known that there are two situations: the relative positional relationship does not satisfy the second preset condition and the relative positional relationship satisfies the second preset condition. In some embodiments, the path generation module 240, in response to the relative positional relationship not satisfying the second preset condition, implementing parking, includes: in response to determining that the relative positional relationship does not satisfy the second preset condition, generating an emergency braking instruction through a braking controller, and sending the emergency braking instruction to a vehicle braking system. The vehicle braking system cuts off a vehicle power output and applies braking until the vehicle stops based on the emergency braking instruction.

The braking controller refers to an electronic control unit responsible for vehicle longitudinal motion control and safety, configured to monitor the relative positional relationship in real-time.

The emergency braking instruction refers to an instruction for emergency braking of the ego vehicle, having the highest priority in vehicle control. The emergency braking instruction includes a request to cut off a vehicle power and a trigger signal for applying braking.

The vehicle braking system refers to a by-wire brake execution mechanism located in the chassis domain of the ego vehicle, including a plurality of components such as a hydraulic control unit, an electric booster pump, brake pipelines, and brake calipers for four wheels. In some embodiments, the vehicle braking system may establish physical brake pressure based on the emergency braking instruction.

For the two situations where the relative positional relationship does not satisfy the second preset condition and the relative positional relationship satisfies the second preset condition: In some embodiments, the path generation module 240, in response to determining that the relative positional relationship does not satisfy the second preset condition, generates an emergency braking instruction through a braking controller, and sends the emergency braking instruction to a vehicle braking system. The vehicle braking system performs a braking operation based on the emergency braking instruction, cuts off the vehicle power output, and applies braking until the vehicle stops. The path generation module 240, in response to the relative positional relationship satisfying the second preset condition, enters the conventional control mode.

The conventional control mode may be a fully autonomous driving mode achieved by combining vehicle sensors and the current path. In some embodiments, the path generation module 240 may input the current vehicle body path into the lateral controller of the ego vehicle, so that the lateral controller controls the ego vehicle to perform conventional mode driving based on the current vehicle body path and other information obtained by sensors. Merely by way of example, if Δφ(t(k+1)) is equal to 1°, being less than 2°, Δ(t(k+1)) is equal to 2 m, the path generation module 240 exits the lane-keeping control mode and controls the vehicle to enter the conventional control mode.

In some embodiments of the present disclosure, by introducing an automated emergency braking mechanism, when the path generation module determines that the relative positional relationship does not satisfy the second preset condition, the power is quickly cut off and braking is implemented, ensuring the safety of the autonomous driving system; by coordinating the cutting off of vehicle power and applying braking, the reliability of vehicle braking is ensured, preventing the risk of power interfering with braking and ensuring the vehicle stops smoothly.

In some embodiments of the present disclosure, through the first preset condition and the second preset condition, it is determined that the vehicle can safely switch among the lane-keeping control mode, the conventional control mode, and parking. At the same time, the generated current path is used as the input for the lateral controller in both the lane-keeping control mode and the conventional control mode, making the switching between the two autonomous driving modes smoother, thereby improving the control accuracy of autonomous driving.

The beneficial effects that may be brought by the embodiments of the present disclosure include but are not limited to: (1) by correcting the ego vehicle position corresponding to the current moment according to the deviation observation value corresponding to the current moment, and generating a path in combination with the lane centerline obtained from the electronic map, a high-precision lane-keeping function is achieved; (2) by obtaining the deviation observation value of the ego vehicle relative to the lane centerline corresponding to the current moment based on the deviation estimation of the ego vehicle relative to the lane centerline corresponding to the current moment and the motion calculation value corresponding to the previous moment obtained through the observer, the deviation estimation of the ego vehicle relative to the lane centerline corresponding to the current moment obtained through inspection can be corrected by the observer, solving the error caused by the inconsistency between the detection cycle and the control cycle, thereby improving the control accuracy of lane keeping; (3) by using the observer to observe the deviation estimations of the ego vehicle relative to the lane centerline obtained through detection and calculation, when the detection cycle and the control cycle are inconsistent leading to low trust in the deviation estimation of the ego vehicle relative to the lane centerline obtained through detection, it can further rely on the deviation estimation of the ego vehicle relative to the lane centerline obtained through calculation to determine the motion calculation value corresponding to the previous moment, thereby improving the control accuracy of lane keeping; (4) the observer determines the first coefficient and the second coefficient based on the ego vehicle environment information, then determines the confidence levels of the deviation values of the ego vehicle relative to the lane centerline corresponding to the previous moment obtained through detection and calculation based on the first coefficient and the second coefficient, so that the motion calculation value corresponding to the previous moment obtained based on the observer can change based on changes in the ego vehicle environment, thereby achieving autonomous driving lane keeping in different environments; (5) by splicing the lane centerline corresponding to the current moment based on the corrected ego vehicle position to generate the current path, point jumps on the current path can be prevented; (6) through the first preset condition and the second preset condition, it is determined that the vehicle can safely switch among the lane-keeping control mode, the conventional control mode, and parking. At the same time, the generated current path is used as the input for the lateral controller in both the lane-keeping control mode and the conventional control mode, making the switching between the two autonomous driving modes smoother, thereby improving the control accuracy of autonomous driving.

It should be noted that different embodiments may produce different beneficial effects. In different embodiments, the beneficial effects produced may be any one or a combination of the above, or any other possible beneficial effects that may be obtained.

The basic concepts have been described above. Obviously, for those skilled in the art, the above detailed disclosure is only an example and does not constitute a limitation on the present disclosure. Although not explicitly stated here, those skilled in the art may make various modifications, improvements, and amendments to the present disclosure. Such modifications, improvements, and amendments are suggested in the present disclosure, so they still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” mean a certain feature, structure, or characteristic related to at least one embodiment of the present disclosure. Therefore, it should be emphasized and noted that “one embodiment” or “an embodiment” or “an alternative embodiment” mentioned two or more times in different locations in the present disclosure does not necessarily refer to the same embodiment. Furthermore, certain features, structures, or characteristics in one or more embodiments of the present disclosure may be appropriately combined.

In addition, unless explicitly stated in the claims, the order of processing elements and sequences, the use of numbers and letters, or the use of other names in the present disclosure is not intended to limit the order of the processes and methods of the present disclosure. Although the above disclosure discusses some currently considered useful invention embodiments through various examples, it should be understood that such details are only for illustrative purposes, and the appended claims are not limited to the disclosed embodiments. On the contrary, the claims are intended to cover all modifications and equivalent combinations that conform to the essence and scope of the embodiments of the present disclosure. For example, although the system components described above may be implemented by hardware devices, they may also be implemented only by software solutions, such as installing the described system on existing servers or mobile devices.

Similarly, it should be noted that in order to simplify the expression disclosed in the present disclosure and thus help the understanding of one or more inventive embodiments, the description of the embodiments of the present disclosure sometimes groups plurality of features into one embodiment, drawing, or description thereof. However, this method of disclosure does not mean that the object of the present disclosure requires more features than those mentioned in the claims. In fact, the features of the embodiments are less than all the features of a single embodiment disclosed above.

In some embodiments, numbers describing the quantity of components and attributes are used. It should be understood that such numbers used in the description of the embodiments are modified by the qualifiers “approximately”, “about”, or “substantially” in some examples. Unless otherwise stated, “approximately”, “about”, or “substantially” indicates that the number allows a variation of ±20%. Accordingly, in some embodiments, the numerical parameters used in the specification and claims are approximate values, which may vary according to the required characteristics of individual embodiments. In some embodiments, numerical parameters should consider the specified significant digits and adopt the method of general digit retention. Although the numerical ranges and parameters used to confirm the breadth of their scope in some embodiments of the present disclosure are approximate values, in specific embodiments, the setting of such numerical values is as precise as possible within the feasible range.

For each patent, patent application, patent application publication, and other materials cited in the present disclosure, such as articles, books, specifications, publications, documents, etc., the entire contents are hereby incorporated into the present disclosure by reference. Except for historical application documents that are inconsistent or conflict with the contents of the present disclosure, and documents that limit the broadest scope of the claims of the present disclosure (currently or later attached to the present disclosure). It should be noted that if the description, definition, and/or terminology usage in the attached materials of the present disclosure is inconsistent or conflicts with the contents of the present disclosure, the description, definition, and/or terminology usage of the present disclosure shall prevail.

Finally, it should be understood that the embodiments described in the present disclosure are only used to illustrate the principles of the embodiments of the present disclosure. Other variations may also fall within the scope of the present disclosure. Therefore, as examples and not limitations, alternative configurations of the embodiments of the present disclosure may be considered consistent with the teachings of the present disclosure. Accordingly, the embodiments of the present disclosure are not limited to the embodiments explicitly introduced and described in the present disclosure.

1. A method for autonomous driving lane-keeping control, comprising:
within a control cycle, obtaining a deviation observation value of an ego vehicle relative to a lane centerline corresponding to a current moment based on a deviation of the ego vehicle relative to the lane centerline corresponding to a previous moment and a deviation observation value of the ego vehicle relative to the lane centerline corresponding to the previous moment, wherein the deviation of the ego vehicle relative to the lane centerline corresponding to the previous moment is obtained based on a detection cycle, including:
based on a lateral velocity and a yaw rate change of the ego vehicle, obtaining an increment of the deviation of the ego vehicle relative to the lane centerline corresponding to the previous moment within the control cycle;
based on the increment of the deviation of the ego vehicle relative to the lane centerline corresponding to the previous moment within the control cycle and the deviation observation value of the ego vehicle relative to the lane centerline corresponding to the previous moment, determining a deviation estimation of the ego vehicle relative to the lane centerline corresponding to the current moment; and
through an observer, based on the deviation estimation of the ego vehicle relative to the lane centerline corresponding to the current moment, the deviation of the ego vehicle relative to the lane centerline corresponding to the previous moment, and the deviation observation value of the ego vehicle relative to the lane centerline corresponding to the previous moment, obtaining the deviation observation value of the ego vehicle relative to the lane centerline corresponding to the current moment;
wherein the observer is a diagonal matrix, the diagonal matrix includes a first coefficient and a second coefficient, and the first coefficient and the second coefficient are greater than 0 and less than 1;
the first coefficient corresponds to a confidence level of the deviation of the ego vehicle relative to the lane centerline corresponding to the previous moment, and the second coefficient corresponds to a confidence level of the deviation observation value of the ego vehicle relative to the lane centerline corresponding to the previous moment; and
at least one of the first coefficient and the second coefficient is determined based on ego vehicle environment information;
correcting an ego vehicle position corresponding to the current moment based on the deviation observation value of the ego vehicle relative to the lane centerline corresponding to the current moment;
obtaining a lane centerline corresponding to the current moment based on a corrected ego vehicle position; and
generating a current path based on the lane centerline corresponding to the current moment, and performing lane-keeping control based on the current path.

2. The method according to claim 1, wherein the through an observer, based on the deviation estimation of the ego vehicle relative to the lane centerline corresponding to the current moment, the deviation of the ego vehicle relative to the lane centerline corresponding to the previous moment, and the deviation observation value of the ego vehicle relative to the lane centerline corresponding to the previous moment, obtaining the deviation observation value of the ego vehicle relative to the lane centerline corresponding to the current moment, includes:
obtaining a motion difference value between the deviation of the ego vehicle relative to the lane centerline corresponding to the previous moment and the deviation observation value of the ego vehicle relative to the lane centerline corresponding to the previous moment;
based on the observer and the motion difference value, obtaining an observation calculation value corresponding to the previous moment; and
based on the deviation estimation of the ego vehicle relative to the lane centerline corresponding to the current moment and the observation calculation value corresponding to the previous moment, obtaining the deviation observation value of the ego vehicle relative to the lane centerline corresponding to the current moment.

3. The method according to claim 1, wherein the method further includes:
at every preset cycle, adjusting the first coefficient and the second coefficient based on an environmental interference characteristic, an observation quality characteristic, and a scene complexity characteristic.

4. The method according to claim 1, wherein the method further includes:
obtaining environment boundary data;
determining a safety boundary based on the environment boundary data and a safety buffer threshold;
determining a critical deviation observation value of the ego vehicle relative to the lane centerline corresponding to the current moment based on the safety boundary; and
in response to the corrected ego vehicle position exceeding the safety boundary, adjusting the deviation observation value of the ego vehicle relative to the lane centerline corresponding to the current moment to the critical deviation observation value.

5. The method according to claim 4, wherein the method further includes:
determining the safety buffer threshold based on a vehicle state parameter and a scene characteristic.

6. The method according to claim 1, wherein the generating a current path based on the lane centerline corresponding to the current moment includes:
when entering a lane-keeping control mode for a first time, generating the current path by curve-connecting the corrected ego vehicle position and the lane centerline corresponding to the current moment; and
when entering the lane-keeping control mode not for the first time, generating the current path by splicing a historical path with the lane centerline corresponding to the current moment.

7. The method according to claim 1, wherein the performing lane-keeping control based on the current path includes:
based on the current path, generating a current vehicle body path; and
based on the current vehicle body path, generating a target steering angle of the ego vehicle through a lateral controller, and sending the target steering angle to a vehicle steering system;
wherein the vehicle steering system generates a target steering torque based on the target steering angle, and drives a steering motor to steer based on the target steering torque.

8. The method according to claim 1, wherein the method further includes:
determining whether a lane line detection result is valid and whether a deviation of the ego vehicle relative to the lane centerline detected within the detection cycle satisfies a first preset condition;
in response to determining that the lane line detection result is valid and the deviation of the ego vehicle relative to the lane centerline detected within the detection cycle satisfies the first preset condition, determining the deviation observation value of the ego vehicle relative to the lane centerline corresponding to the current moment; and
in response to determining that the lane line detection result is not valid or the deviation of the ego vehicle relative to the lane centerline detected within the detection cycle does not satisfy the first preset condition, exiting a lane-keeping control mode.

9. The method according to claim 8, wherein the method further includes:
after exiting the lane-keeping control mode, determining whether a relative positional relationship between the ego vehicle and the lane centerline satisfies a second preset condition;
in response to determining that the relative positional relationship does not satisfy the second preset condition, implementing parking; and
in response to determining that the relative positional relationship satisfies the second preset condition, entering a conventional control mode.

10. The method according to claim 9, wherein the in response to determining that the relative positional relationship does not satisfy the second preset condition, implementing parking, includes:
in response to determining that the relative positional relationship does not satisfy the second preset condition, generating an emergency braking instruction through a braking controller, and sending the emergency braking instruction to a vehicle braking system;
wherein the vehicle braking system cuts off a vehicle power output and applies braking until the vehicle stops based on the emergency braking instruction.

11-13. (canceled)
